(19) United States
(12) Patent Application Publication
(10) Pub. No.: US 2002/0121982 A1
(43) Pub. Date: Sep. 5, 2002

(54) Water alarm for sensing a level of water in a tub

(76) Inventors: Susan Ferris, New York, NY (US); Alma Phipps, New York, NY (US); John Sinisi, Warminster, PA (US); Robert Bernhard, Yancey, PA (US)

Correspondence Address: GOTTLIEB RACKMAN & REISMAN PC, 270 MADISON AVENUE, 8TH FLOOR, NEW YORK, NY, 100160601

(21) Appl. No.: 09/796,849

(22) Filed: Mar. 1, 2001

(51) Int. Cl. G08B 21/00

(52) U.S. Cl. 340/612; 340/540; 340/603

(57) ABSTRACT

An integrated device for detecting a desired level of water in a tub, hot tub, sink or the like. The device incorporates a water sensor, sound processor and speaker into a housing that has the outward appearance of a whistle. The device mounts to a vertical side of the tub or other water container by a swiveling suction cup which allows the water sensor incorporated in the bottom of the device to remain level with respect to a rising surface of water. Upon the detection of the water level by the water sensors, the sound processor generates a varying series of sounds to alert a user. The varying sounds provide the user with information concerning the time that has passed since the initial detection of the water level.

### FIELD OF INVENTION

This invention relates to devices for the detection of a surface level of water. More particularly, the invention relates to a device that will sound an alarm when a sensor detects a predetermined water level in a bathtub, hot tub, sink, pool, or other similar water container, located in a home, office or other non-industrial site.

### BACKGROUND OF INVENTION

The act of filling a bathtub has been a continued annoyance for generations. Bathtub filling often requires a long amount of time because of the amount of water required and the relatively slow flow rate of the water. During this tub filling time, the rising water level must be constantly observed so that the potential bather can: a) know when the bath water reaches the desired water level and b) avoid the occurrence of an overflow. However, few people have the patience to stand and wait for a tub to fill. The situation often results in a seemingly endless cycle of leaving and returning to check on the progress of the water level.

Prior devices exist for detecting water levels. For example, Kelley et al. U.S. Pat. No. 4,227,190 shows a water alarm for detecting moisture on a floor surface. Tennenhouse et al. U.S. Pat. No. 4,137,527 teaches a device to detect water in a flooding basement. Wickremasinghe U.S. Pat. No. 5,493,877 teaches as device for sensing the water level in a washing machine. The patents to Crossley U.S. Pat. No. 2,143,476, Hammand U.S. Pat. No. 2,360,338, Scully U.S. Pat. No. 2,910,956, and Haynes U.S. Pat. No. 2,935,099 all show audible air whistles to detect when an enclosed industrial tank is full. No such device has been offered to work in the non-industrial, bathroom tub environment in a convenient and easy-to-use manner for consumers.

Moreover, some of these devices detect water with an electrode water sensor attached by wires to a separate alarm housing. This configuration is sub-optimal for three reasons: (1) the use of long wire electrode sensors complicates installation by requiring the added steps of mounting both the sensor and the alarm housing on separate remote surfaces. The sensor must then be installed near the water. The alarm housing also needs to be installed away from the water to prevent the device from falling in the water. (2) When so secured, the safety of the device and the reliability of its performance are at risk. The wire connecting the water sensor becomes a potential tangle or pull hazard that could cause the alarm housing to fall to the water or become detached from the water sensors. (3) Because the remote sensor requires more parts, it is more costly to manufacture.

Another problem associated with prior art devices involves the alarm. Prior devices provide only an unvarying alarm sound once the water level is detected. The alarm continues to sound until the sensors are removed from the water or the device is switched off. As such, the continuous alarm becomes an annoyance if the device can not be reached immediately. Moreover, with such a continuous unvarying alarm, a user can not tell how long the alarm has been sounding and thus, can not judge the degree of urgency with which to respond to the alarm.

### SUMMARY OF THE INVENTION

In its broadest aspects, the present invention relates to an integrated device that can provide a warning of a desired level of water in a bathtub, hot tub, sink, pool, or the like. The water alarm can be easily mounted on the inside vertical surface of a bathtub to detect a desired level of water. A higher mounting on the vertical surface will allow for a higher level of water to enter the tub before activation of the alarm, while a lower mounting will warn of a lower level.

The device is simply mounted to a bathtub side wall surface by means of a swiveling suction cup connected at the top shell portion of the device. The swivel action allows the heavier bottom shell portion of the device to rotate down and level itself so that the base of the device is parallel to the water—ensuring that the water sensors incorporated into the base will make contact with a rising level of water. When water reaches the water sensors, the device will generate a programmed series of sounds. The sounds progress over time from being more pleasant to being more urgent if the device is not deactivated.

The fully integrated device has an upper on/off button, a top shell, a bottom shell and bottom lid with incorporated water sensors which when fully assembled has the outward decorative appearance of a whistle. The whistle-like design serves to promote the projection of sound from the device and is pleasant to view.

### OBJECTIVES OF THE INVENTION

In view of prior art deficiencies, it is the objective of the present invention to provide a new and improved water level sensor that is:

a) simple and inexpensive in construction yet reliable in operation;

b) more easily, safely, and effectively installed;

c) more pleasing to the ear and more able to communicate varying degrees of urgency; and

d) more suitable for use in a non-industrial, more decorative consumer environment, usually a home or office.

Taking each of these attributes in turn . . .

a) Simple Inexpensive Construction

By integrating the sensors and the alarm into one physical unit, the present water level sensor eliminates the remote, tethered, sensing device of other commercialized alarms, thus improving, simplifying and reducing the manufacturing cost.

Further economy of parts is achieved in two ways:

(1) Several parts have more than one function. For example:

The exterior wall of the chamber is not only the exterior wall, but also acts as the water-tight chamber for the batteries, preventing the need (and additional cost) for an interior water-tight wall.

The same screws that secure the bottom lid to the bottom shell also act as the sensor probes that detect the water level surface, preventing the need for a separate sensor.

(2) Several elements of the preferred design—a cylindrical whistle—have functional as well as decorative reasons for being. These include:

The sweeping angular curve of the on-off button both cushions the index finger as it presses the button and gives the appearance of the mouthpiece of a whistle;

The sound aperture not only emits the sound but also resembles the opening in a whistle;

The internal supports for the speaker—several parallel vertical strips —not only hold the speaker but also look, from the outside, like the reeds of a whistle.

As a result of such efficiencies, manufacturing costs can be optimized. A maximum of only three molds are required to make the parts: (1) the on-off button; (2) the body (including the top and bottom shells, innards, and bottom lid); and (3) the suction cup. If the button and body are the same color and the suction cup is sourced out, only one mold is required—keeping manufacturing costs t a minimum.

b) Easy, Safe, Effective Installation

Three features of the present water level sensor make installing it easier and safer than installing other commercialized water level alarms:

(1) Since the alarm and sensor are integrated into one unit, there is no need to mount the alarm and sensor separately in two remote locations.

(2) Since the battery chamber is water-tight, the device will still function even if the section containing the batteries gets wet.

(3) The suction cup at the top portion of the device, which acts to secure it to the bathtub wall, has a unique swiveling feature.

This swiveling suction cup makes the device both self-righting and self-leveling. No matter which direction the device is in when the user attached the suction cup, the swivel action causes the heavier bottom shell portion of the device to rotate down and level itself into the correct, upright operating position—with the base parallel to the water level and the alarm-triggering sensors properly positioned to make contact with the rising water.

The swiveling suction cup also helps keep the speaker dry when the tub has filled. Once the water level in the bathtub has reached the bottom of the device and its alarm has begun to sound, pressure from any continued flow of water will cause the device to tilt (on the suction cup's pivot) away from its initial vertical position into a more horizontal position. This has the effect of keeping the alarm speaker drier, longer, and moving it further away from the muffling effect of the rising water.

c) More Pleasing, More Varied Alarm Sound

The water sensor's alarm consists of a programmed series of sounds. Initial sounds are pleasing, even playful—simulating, for example, the sound of a human “come hither” whistle or call, the “quack” of a rubber duck, or the “toot” of a tugboat. If the device is not de-activated, the sounds progress over time from being pleasant to being more alarming—simulating, for example, the sound of a siren or fire alarm. The type of sound communicates to the user the length of time that has passed since the water reached—or surpassed—the desired level. Varying sounds signal varying levels of urgency.

d) Suited for a Non-Industrial Environment

Because it is a single integrated device (with sensors and alarm incorporated into one physical unit) that is simple to use, pleasing to hear, pleasant to handle and look at, the water sensor suits a non-industrial, decorative, consumer environment.

In its fundamental design, the fully integrated water sensor is essentially a simple tube, sized to fit comfortably in the user's palm. The design is adapted to be a decorative object such as a cartoon character, tug boat, whistle, rubber duck, etc. In its preferred design, it has the outward decorative appearance of a whistle with an on-off switch at its mouthpiece.

However, the fundamental design is intentionally flexible so that several other variants equally suited to consumer environments can be produced at varying price points, without jeopardizing the essential objectives of the invention. For example, the on/off button could be eliminated without sacrificing the basic convenience and functionality of the device. The head of a cartoon figure could be painted or fitted over the top of the tube (like the ones currently fitted onto the tops of Johnson and Johnson baby shampoo), without sacrificing the basic shape of the device. A thermometer capable of detecting bath water temperature could be added to the device within the scope of its fundamental purpose—which is to signal when the bath is ready. Alternatively, the top shell could be molded to appear as a different shape such as the head of a cartoon character, animal figure or some other decorative appearance, provided that the new top shell shape will connect with the bottom shell and provided that the new top shell also will have an opening to allow the escape of sound from the speaker and a connection for the suction cup.

### DESCRIPTION OF DRAWINGS

FIG. 1 is a vertical cross-section of the inside of a tub with the inventive water alarm mounted thereon;

FIG. 2 is an elevational view of the top of the water alarm mounted to a tub surface;

FIG. 3 shows an exploded view of the water alarm;

FIG. 4 is a perspective view of the water alarm;

FIG. 5 is a vertical cross-sectional view of the water alarm;

FIG. 6 is a breakaway view of the momentary switch within the water alarm;

FIG. 7 is a bottom of the water alarm;

FIG. 8 is a top down view of the structure of the top shell of the water alarm taken along the line 8-8 of FIG. 5;

FIG. 9 depicts a horizontal cross-sectional view of the bottom shell of the water alarm taken along the line 9-9 of FIG. 5;

FIG. 10 is a diagram of the electric circuit used in the preferred embodiment of the water alarm;

FIG. 11 is a flow chart of the sound program from the preferred embodiment of the water alarm.

### DETAILED DESCRIPTION OF THE INVENTION

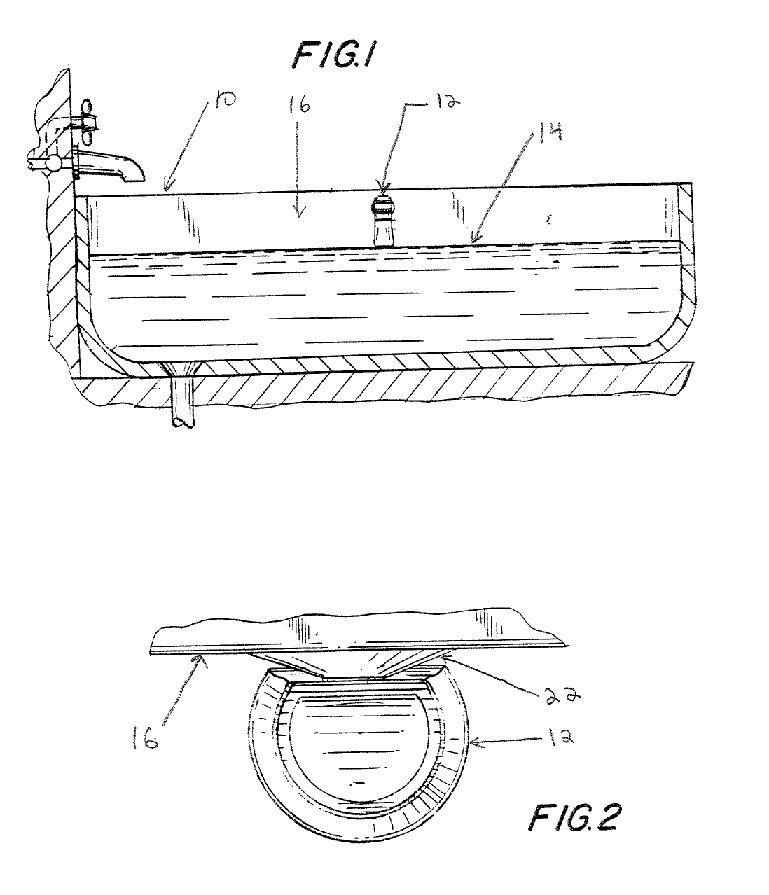

FIG. 1 depicts the inventive water alarm 12. The water alarm 12 is mounted to an inside vertical surface 16 of a tub 10. The device sounds an alarm when a water level 14 is detected at the base of the water alarm 12. The desired level of water that will be detected depends on the vertical height of the water alarm 12 when mounted to the surface 16. In FIG. 2, the water alarm 12 is further shown mounted to the surface 16 by a suction cup 22.

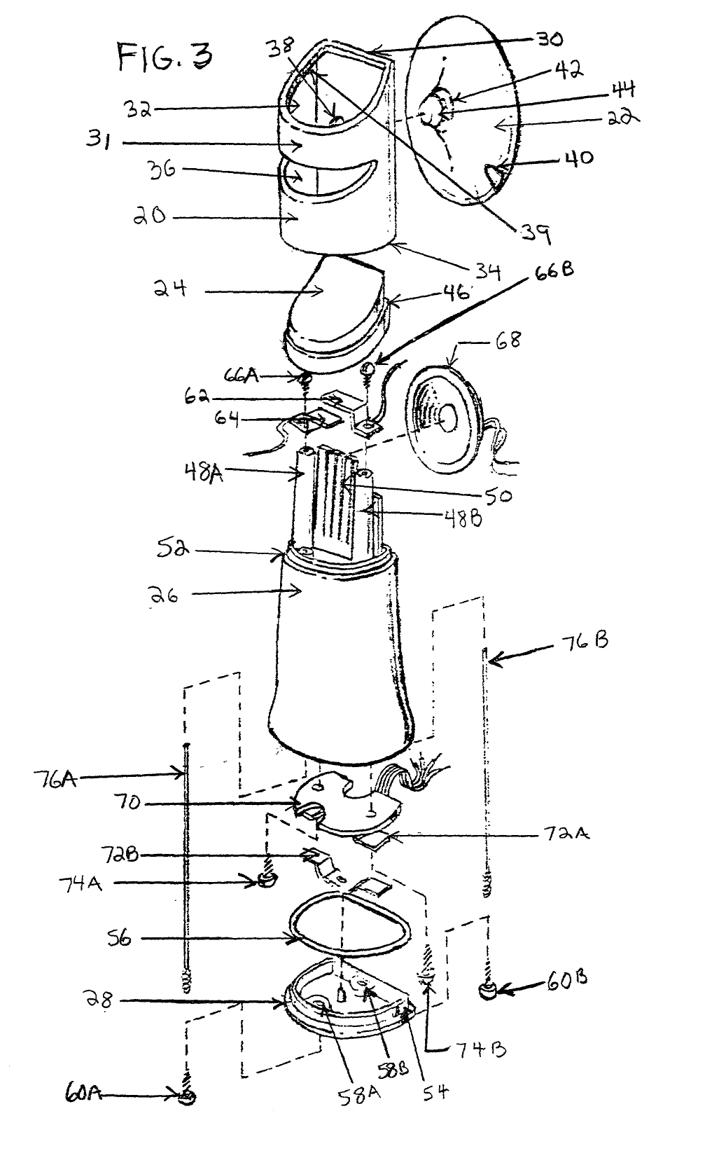

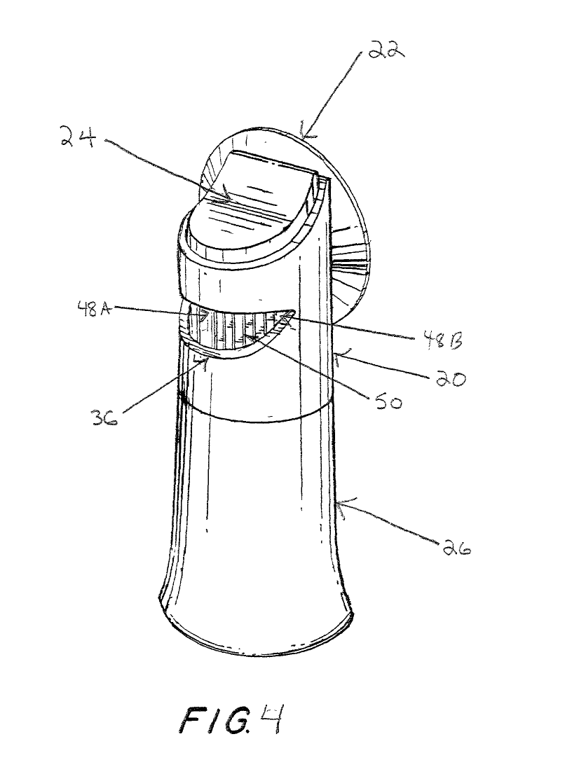

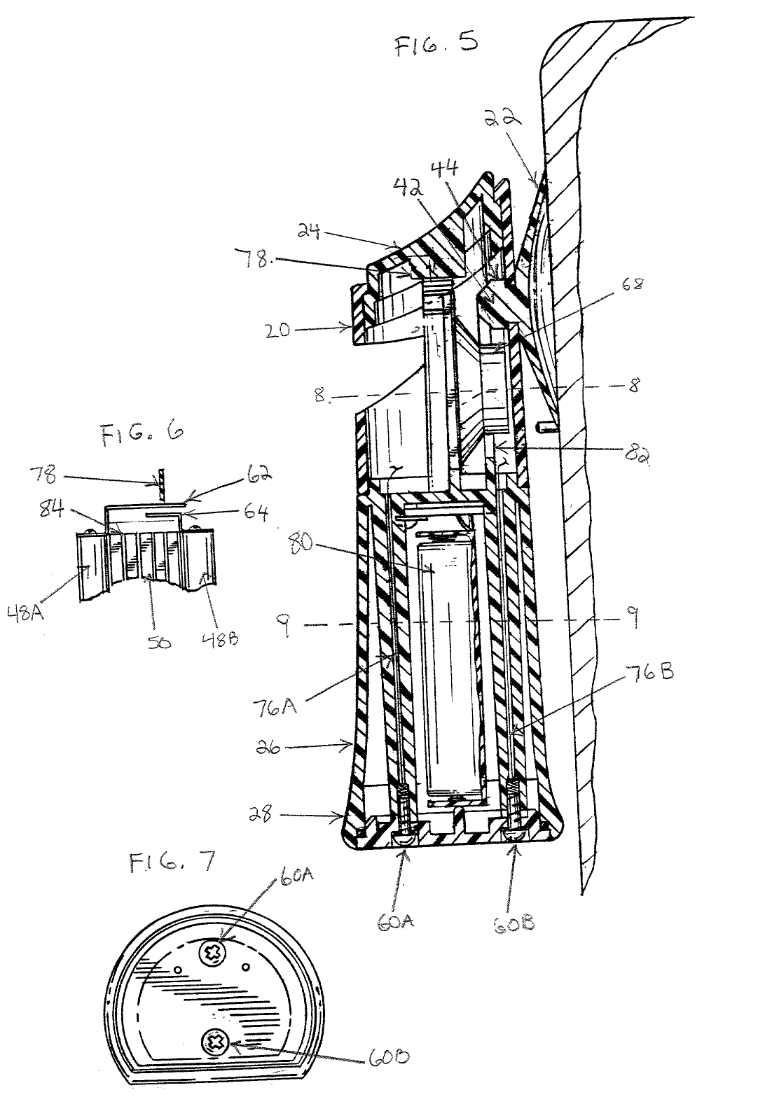

FIG. 3 shows details of the components of the water alarm 12. Reference is also made to FIGS. 4 and 5. The external structure of a fully assembled water alarm 12 of the present invention comprises five basic parts, namely, a top shell or housing 20, a suction cup 22, an on/off button 24, a bottom shell or housing 26, and a bottom lid 28.

The top shell 20 has a generally cylindrical shape with a flat posterior side 30, a rounded anterior side 31, a top opening 32 and bottom opening 34. The top opening 32 has an angular edge such that the edge proximate to the flat posterior side 30 is higher than the edge proximate to the rounded anterior side 31. This angular edge provides the top shell 20 with the appearance of a mouthpiece of a whistle.

The top shell 20 has a sound aperture 36 and a mounting hole 38. The top opening 32 has a rim 39 making the top opening smaller than the bottom opening 34. The size and cylindrical shape of the top shell 20 forms an internal sound chamber. In the fully assembled water alarm 12, the internal sound chamber coupled with the sound aperture 36 serve to amplify the alarm sound that emanates from the device.

The suction cup 22 is used for mounting the water alarm 12 and has a suction release tab 40 and round central connection tip 42. The connection tip 42 has a lip 44 that is larger in diameter than the base of the connection tip 42. The lip 44 is also larger than the diameter of the mounting hole 38. The base of the connection tip 42 is slightly smaller in diameter than the mounting hole 38. The relative sizes among the connection tip 42, the lip 44 and the mounting hole 38 allow for the suction cup 22 to be swivally affixed to the top shell 20, enabling rotation about a horizontal axis. As seen in FIG. 5, the connection tip 42 is inserted into the top shell 20 through the mounting hole 38. The larger lip 44 keeps the suction cup 22 retained within the top shell 20 while the slightly smaller base of the connection tip 42 allows the top shell 20 to swivel with respect to the suction cup 22. As a result of the position of the mounting hole 38 on the top shell 20 and the relatively heavier weight of the bottom shell 26, the swivel action allows the water alarm to maintain a relatively vertical position when installed on a vertical surface. This vertical position further ensures that the bottom lid 28 will be generally parallel to the surface of a level of water while the water is below the water alarm 12. Once the water touches the bottom of the device, the swivel action causes the device to respond to the force of any continued water flow by rotating toward the horizontal plane—thereby tilting the speaker away from the muffling effect of the water.

The on/off button 24 is comparably shaped and sized with the top shell 20 so that the button 24 may slide within the top shell 20. A ridge 46 separates a top portion and bottom portion of the button 24. When inserted within the top shell 20 through the bottom opening 34, the top portion of the button 24 protrudes from the top opening 32 and is prevented from complete egression through the top opening 32 by contact between the ridge 46 and the rim 39. The protrusion of the button 24 through the top shell 20 can be seen in FIG. 4. Although not visible from FIG. 3, the button 24 also has an extension tab. The extension tab 78 protrudes from the underside of the button 24 and can be seen in FIG. 5. When assembled into the water alarm 12, the extension tab portion of the button 24 extends down to meet the top contact 62 allowing for a gap between the top contact 62 and the bottom contact 64.

FIG. 6 also shows the extension tab 78 (separated from the button 24 for purposes of the drawing) meeting the top contact 62. When the button 24 is depressed, the extension tab 78 closes a circuit between the top contact 62 and the bottom contact 64. When the button 24 is released, tension in the top contact 62 will open the circuit and force the button to return to its pre-depressed position.

Continuing with FIG. 3, the bottom shell 26 is watertight and has a generally cylindrical shape with an outwardly flanging bottom and a flat posterior side that forms an internal chamber. The bottom shell also has two contact posts 48A, 48B and a front support 50 for a speaker 68. The front support 50 is made from several parallel vertical projections with gaps between each. The projections and gaps give the appearance of a reed from a whistle. As depicted in FIG. 4, the projections and gaps of the front support 50 and the contact posts 48A, 48B are partially visible in the fully assembled water alarm 12 through the sound aperture 36 of the top shell 20 which is consistent with the water alarm's whistle-like appearance.

Returning to FIG. 3, the bottom shell also has a ledge 52 with a shape and size corresponding to the bottom opening 34 of the top shell 20 so that the ledge 52 can be removably attached within the bottom opening 34.

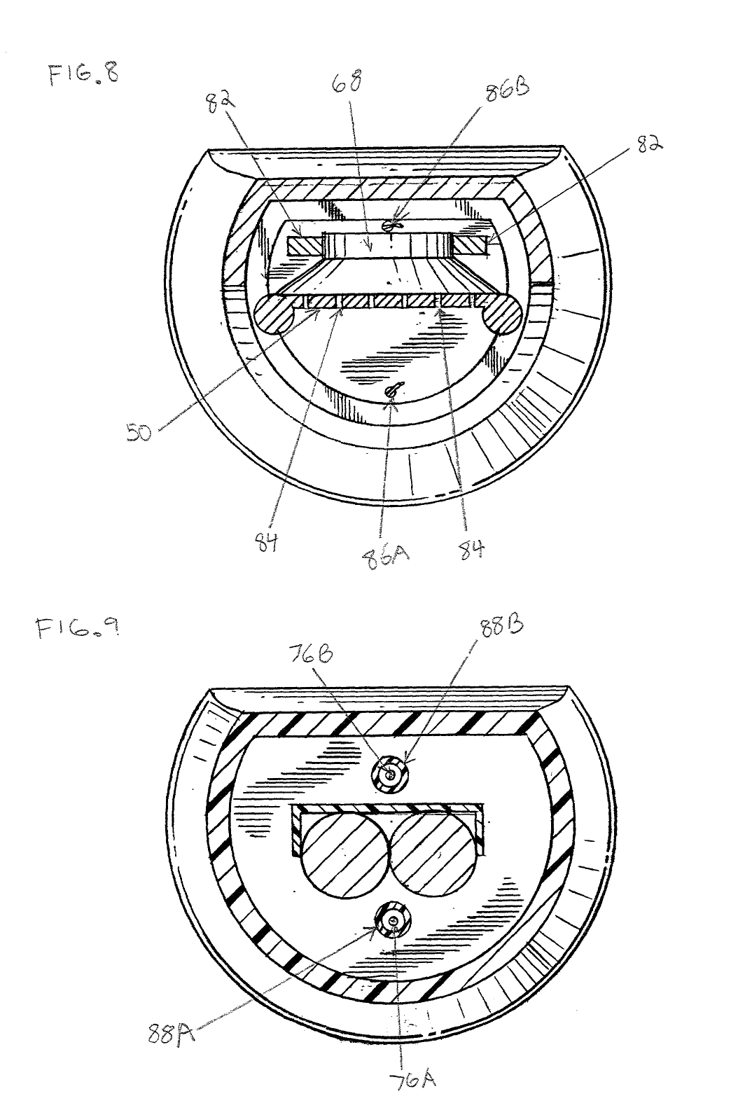

The bottom lid 28 has a shape and size for sealing the internal chamber of the bottom shell 26 with an edge 54 to receive a sealing gasket 56. The bottom lid 28 has two holes 58A, 58B to receive sensor screws 60A, 60B. With the sealing gasket 56 installed and the bottom lid 28 secured to the bottom shell 26, the bottom shell 26 is watertight. Water will be prevented from seeping within the bottom shell 26. As also seen in FIGS. 5 and 7, sensor screws 60A, 60B serve to secure the bottom lid 28 onto the bottom shell 26. The sensor screws 60A, 60B also act as the probes that detect a water surface level.

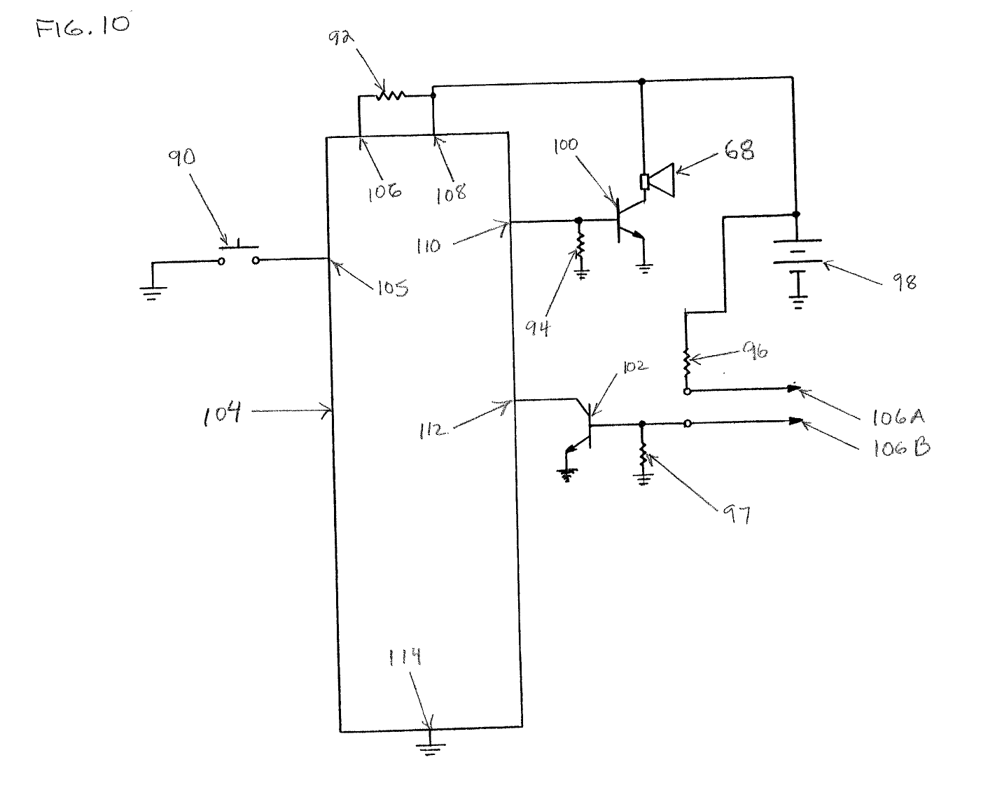

Continuing with FIG. 3, the internal components of the water alarm are generally affixed within or to the bottom shell 26. A top contact 62 and bottom contact 64 are affixed to the bottom shell 26 by attaching contact screws 66A, 66B to the contact posts 48A, 48B. A speaker 68 is installed behind the front support 50. As best seen in FIG. 8, the speaker 68 is held in place by a front support 50 and a rear support 82. Gaps 84 between vertical projections of the front support 50 allow sound to pass through the support from the speaker 68.

Returning again to FIG. 3, the following internal components are affixed within the chamber formed by the bottom shell 26. The chamber contains a circuit board 70 and an upper power source terminal 72A secured by two screws 74A, 74B. A lower power source terminal 72B is attached to the bottom lid 28. The chamber also contains two conducting sensor extensions 76A, 76B each having a spring on one end.

As shown in FIGS. 3 and 5, the sensor extensions 76A, 76B are installed within channel openings formed in the bottom shell 26 and in contact with the sensor screws 60A, 60B. FIG. 9 depicts the sensor extension channel openings 88A, 88B through which the sensor extensions 76A, 76B extend. As seen in FIG. 5, the water alarm 12 has an installed power source 80 located within the bottom shell 26. A rear support 82 provides additional structural support for the speaker 68.

The water alarm 12 utilizes an electrical circuit to trigger the sound alarm upon the detection of a water surface. A preferred embodiment of the electrical circuit is depicted In FIG. 10. The circuit incorporates a momentary switch 90, a 1.2M ohm resistor 92, a 330 ohm resistor 94, a 1 k ohm resistor 96, a 1M ohm resistor 97, a 3 volt power supply 98, an “8050” type BJT 100, an “9014” type BJT 102, a speaker 68 and a sound IC 104. The circuit has two probe terminals 106A, 106B. In the fully assembled embodiment of the water alarm 12, the momentary switch 90 is made as shown in FIG. 5, 6, by combining the on/off button 24 with extension tab 78, the top contact 62 and bottom contact 64. As seen in FIG. 3, each probe terminal 106A, 106B is connected to the sensor extension 76A, 76B which in turn makes contact with a sensor screw 58A, 58B by the spring on the sensor extension 76A, 76B. When water shorts, or electrically connects, the two sensor screws 58A, 58B, the sound IC 104 is triggered.

Returning to FIG. 10, as noted the water alarm 12 uses a sound IC 104. The sound IC 104 is programmable and generates a signal for the speaker 68 to sound an alarm. Many different versions of the sound IC 104 may be used to generate the sound signal. One such sound IC 104, is the ADPCM Voice Synthesizer model W5289S03, manufactured by Winbond Electronics Corporation, and available from Winbond Electronics Corporation America, 2727 N. First Street, San Jose, Calif. 95134, U.S.A. Tel: 1-408-9436666. The connection pins on the W5289S03 sound IC 104 that are used in the preferred embodiment include the first trigger input pin 105, the oscillation frequency control pin 106, the VDD positive power supply pin 108, the speaker pin 110, the second trigger input pin 112, and the VSS negative power supply pin 114.

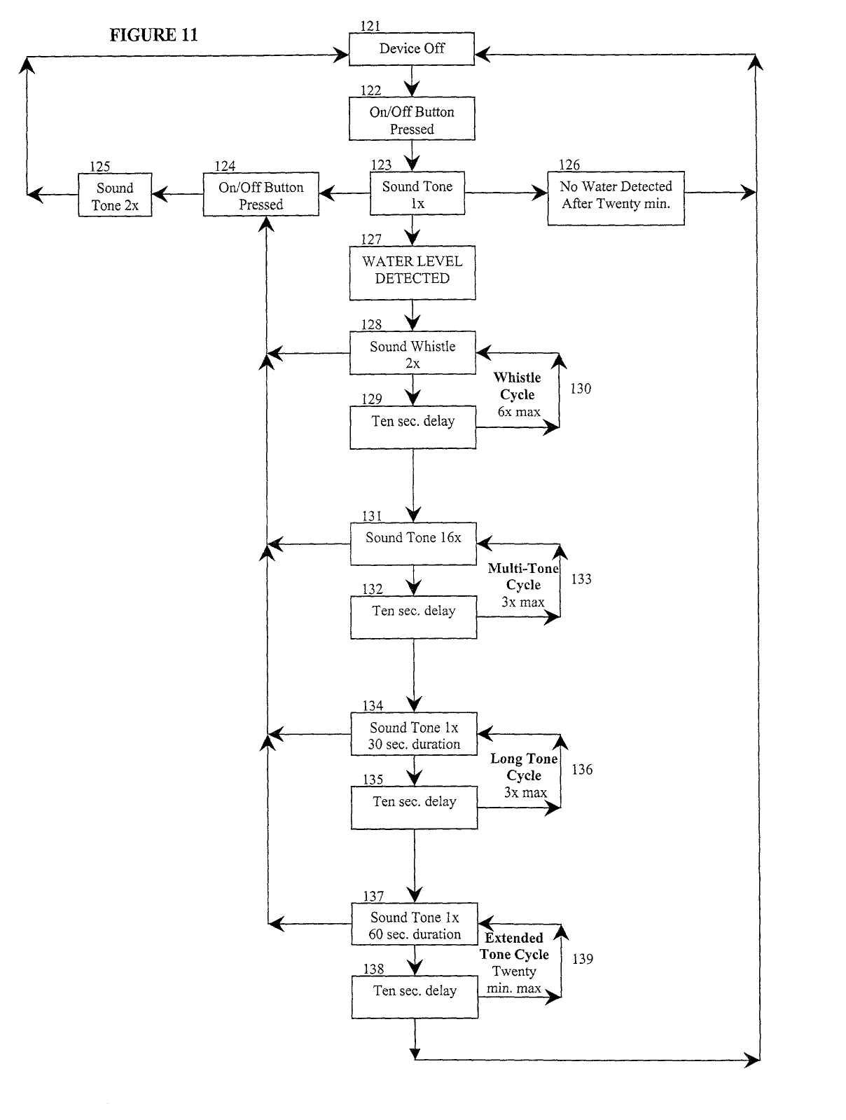

In the preferred embodiment, the sound IC 104 generates a series of programmed signals to produce an alarm sound that varies over time. While many different versions of the program are possible, FIG. 11 depicts a flowchart of one such sound routine generated by the sound IC 104 and played by the speaker 68 of the water alarm 12. Alternatives to the specific sound IC 104 and circuit include a memory to store an alarm sound program and a processor to generate a sound signal using the stored program.

Referring to FIG. 11, the device in a preferred form, starts in an off state, step 121. When the button 24 is pressed, step 122, a single short duration tone is produced, step 123, at the speaker 68. The next step is dependent upon whether the button 24 is pressed, step 124, or whether a water level is detected. If the button is pressed, step 124, two short duration tones are produced, step 125, and the device returns to the off state, step 121. Alternatively, if after the expiration of 20 minutes no water is detected, step 126, the device returns directly to the off state, step 121 to prevent further loss of power. However, if a water level is detected, step 127, across the sensor screws 60A, 60B, a whistle cycle 130 is entered.

The whistle cycle 130 starts with the alarm sounding a simulated sound that is a human “come hither” type whistle two times, step 128. After the second whistle, the device will issue no sound for a delay of ten seconds, step 129, unless the button 24 is pressed, step 124, in which case the water alarm 12 will return to the off state, step 121, as described above. After the ten-second delay, step 129, the water alarm will return to sounding the whistle two times, step 128, to begin the whistle cycle 130 again. The whistle cycle 130 will be repeated no more than six times.

After the whistle cycle 130, the device will enter the multi-tone cycle 133. The multi-tone cycle 133 starts with the sounding of a short duration tone sixteen times, step 131. If the on/off button is not pressed, step 124, then a ten-second delay, step 132, with no sound will occur. After the delay, step 132, the multi-tone cycle 133 will repeat by sounding sixteen short duration tones, step 131. The multi-tone cycle 133 will repeat no more than three times.

After the multi-tone cycle 133, a long tone cycle 136 is entered. The long tone cycle starts with the water alarm 12 sounding a single tone for a duration of thirty seconds, step 134. If the on/off button 24 is not pressed, step 124, then a ten second delay will occur, step 135, with no sound from the water alarm 12. After the delay step 135, the cycle will repeat to sound the thirty second tone, step 134. The long tone cycle 136 will repeat no more than three times.

After the long tone cycle 136, an extended tone cycle 139 is entered. The cycle is started when the water alarm 12 sounds a single sixty second tone, step 137. If the on/off button 24 is not pressed, step 124, then a silent ten second delay will occur, step 138 after which, the extended tone cycle 139 will repeat. The extended tone cycle 139 will repeat for no longer than twenty minutes after which time, the water alarm 12 will return to the off state, step 121.

Although this invention has been described with reference to a particular embodiment, it is to be understood that this embodiment is merely illustrative of an application of the principles of the invention. Numerous modifications to the illustrative embodiment discussed herein may be made and other arrangements may be devised without departing from the spirit and scope of the invention.

I claim:

1. An integrated device to detect a desired level of water in an open container in the home, office or other non-industrial setting comprising:
a housing adapted to be attached to an inside wall of said container with a suction cup;
a water sensor incorporated on the lower surface of said housing;
a micro-controller to generate an alarm signal in response to a detection of a level of water by said water sensor; and
a speaker within said housing to generate sound from said alarm signal.

2. The device of claim 1 wherein said housing is adapted to be a decorative object.

3. The device of claim 2 wherein said decorative object comprises at least one feature of a whistle from a group of features comprising (a) a mouthpiece; (b) a reed; and (c) a sound aperture.

4. The device of claim 2 wherein said decorative object has the outward appearance of a whistle.

5. The device of claim 1 wherein said housing comprises a sound chamber with a sound aperture to amplify said sound from said alarm signal.

6. The device of claim 1 wherein said sound from said alarm signal comprises a simulated sound.

7. The device of claim 6 wherein said simulated sound is a human whistle.

8. The device of claim 1 wherein said sound from said alarm signal comprises an intermittent series of sounds varying over a period of time.

9. The device of claim 8 wherein said series of sounds comprises a simulated sound cycle and a tone cycle.

10. The device of claim 1 wherein said suction cup swivels independent from said housing.

11. The device of claim 1 wherein said suction cup swivels independent from said housing such that: the said water sensors in said housing gravitate to a lower position nearest said level of water.

12. The device of claim 11 wherein said suction cup further swivels such that said housing rotates into a more horizontal position when in contact with a rising body of water.

13. The device of claim 1 wherein said housing includes a watertight chamber with a power source.

14. The device of claim 1 wherein said housing comprises an on-off button.

15. The device of claim 14 wherein the initial pressing of said on-off button activates said device and said device generates a sound.

16. The device of claim 1 further comprising a thermometer.

17. An integrated device to detect a desired level of water in an open container in the home, office or other non-industrial setting comprising:
a housing adapted to be attached to an inside wall of said container with a swiveling suction cup wherein said housing comprises a sound chamber with a sound aperture, an angular shaped on-off button, and a watertight chamber;
a water sensor incorporated on the lower surface of said housing;
a micro-controller to generate an alarm signal in response to a detection of a level of water by said water sensor; and
a speaker within said housing to generate sound from said alarm signal,
wherein said sound from said alarm signal comprises an intermittent series of sounds varying over a period of time.
